(19) United States
(12) Patent Application Publication
(10) Pub. No.: US 2026/0237328 A1
(43) Pub. Date: Aug. 13, 2026

(54) DISPLAY CONTROL METHOD, NON-TRANSITORY COMPUTER-READABLE STORAGE MEDIUM STORING PROGRAM, AND DISPLAY CONTROL SYSTEM

(71) Applicant: SEIKO EPSON CORPORATION, Tokyo (JP)

(72) Inventors: Sayaka UCHIYAMA, MATSUMOTO-SHI (JP); Takayuki YOKOYAMA, MATSUMOTO-SHI (JP)

(21) Appl. No.: 19/535,729

(22) Filed: Feb. 10, 2026

(30) Foreign Application Priority Data
Feb. 10, 2025 (JP) 2025-020220

(51) Int. Cl. G09G 3/00; G06F 3/14

(52) U.S. Cl. CPC G09G 3/001; G06F 3/1423; G09G 2320/0626; G09G 2360/144

(57) ABSTRACT

According to an aspect of the present disclosure, there is provided a display control method executed by a support server and including acquiring information indicating first illuminance that is illuminance of an environment in which a first projector belonging to a first management group that is a management group serving as a unit for managing a plurality of projectors is disposed and determining, based on the information indicating the first illuminance, control information for controlling brightness of an image projected by a second projector belonging to the first management group.

The present application is based on, and claims priority from JP Application Serial Number 2025-020220, filed Feb. 10, 2025, the disclosure of which is hereby incorporated by reference herein in its entirety.

### BACKGROUND

### 1. Technical Field

The present disclosure relates to a display control method, a non-transitory computer-readable storage medium storing a program, and a display control system.

### 2. Related Art

JP-A-2023-124277 Discloses a Configuration including an illuminance sensor that detects the illuminance of an environment in which a projector is disposed and controlling, according to the illuminance detected by the illuminance sensor, the brightness of an image projected by the projector.

JP-A-2023-124277 is an example of the related art.

A projector not including an illuminance sensor cannot detect the illuminance of an environment in which the projector is disposed. For that reason, unlike the configuration disclosed in JP-A-2023-124277, the brightness of an image projected by the projector cannot be controlled according to the illuminance of the environment in which the projector is disposed.

### SUMMARY

According to an aspect of the present disclosure, there is provided a display control method including: acquiring information indicating first illuminance that is illuminance of an environment in which a first projector belonging to a first management group that is a management group serving as a unit for managing a plurality of projectors is disposed; and determining, based on the information indicating the first illuminance, control information for controlling brightness of an image projected by a second projector belonging to the first management group.

According to an aspect of the present disclosure, there is provided a non-transitory computer-readable storage medium storing a program for causing a computer to execute: acquiring information indicating first illuminance that is illuminance of an environment in which a first projector belonging to a management group serving as a unit for managing a plurality of projectors is disposed; and determining, based on the information indicating the first illuminance, a control condition for controlling brightness of an image projected by a second projector belonging to the management group.

According to an aspect of the present disclosure, there is provided a display control system including: an illuminance sensor configured to detect illuminance of an environment in which a first projector is disposed; a second projector; and a control device configured to determine, based on the illuminance detected by the illuminance sensor, a control condition for controlling brightness of an image projected by the second projector.

### BRIEF DESCRIPTION OF THE DRAWINGS

FIG. 1 is a configuration diagram of a display control system according to an embodiment.

FIG. 2 is a diagram illustrating a management table for a plurality of projectors.

FIG. 3 is a flowchart of diversion control for illuminance information in subgroup units.

FIG. 4 is a diagram illustrating a luminance mode control range.

FIG. 5 is a diagram illustrating a correspondence relationship between luminance mode setting and illuminance.

FIG. 6 is a diagram illustrating a management table for a plurality of projectors in another embodiment.

### DESCRIPTION OF EMBODIMENTS

### 1. Configuration of a Display Control System

An embodiment is explained below with reference to the drawings.

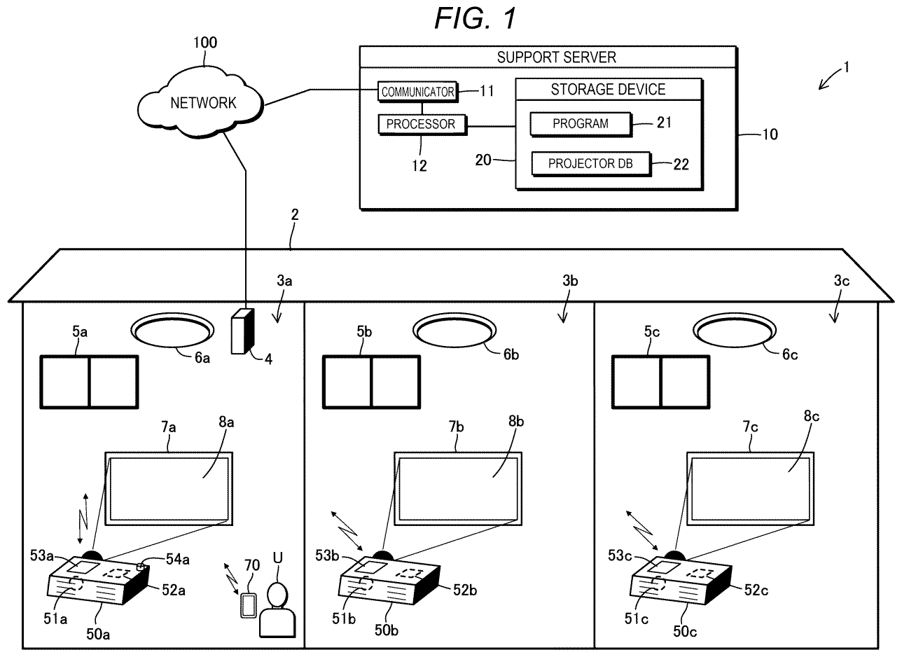

FIG. 1 is a configuration diagram of a display control system 1 according to the present embodiment. The display control system 1 includes a first projector 50a, a second projector 50b, and a third projector 50c used in a building 2 and a support server 10.

The support server 10 communicates with the first projector 50a, the second projector 50b, the third projector 50c, and a communication terminal 70 used by a user U via a network 100 and a router 4 disposed in the building 2. The communication terminal 70 is a personal computer, a smartphone, a tablet terminal, a mobile phone, or the like. The support server 10 is equivalent to a control device of the present disclosure. The support server 10 may be referred to as server or server device.

The first projector 50a is disposed in a first area 3a including a first window 5a and a first light 6a and projects a first image 8a onto a first screen 7a. The first projector 50a includes a first light source 51a, a first controller 52a, a first operation unit 53a, and an illuminance sensor 54a.

The illuminance sensor 54a detects the illuminance of an environment in which the first projector 50a is disposed. Hereinafter, the illuminance detected by the illuminance sensor 54a is referred to as detected illuminance as well. In the present embodiment, the illuminance sensor 54a detects the illuminance of the first area 3a. The illuminance sensor 54a is a photoelectric conversion element that converts received light into an electric signal and includes a photodiode or a phototransistor. The illuminance sensor 54a may not be provided in the first projector 50a and a single illuminance sensor 54a may be disposed in a predetermined part in the first area 3a. In this case, the illuminance sensor 54a has a communication function and information concerning the detected illuminance is transmitted from the illuminance sensor 54a to the support server 10 directly or via the first projector 50a.

The second projector 50b is disposed in a second area 3b including a second window 5b and a second light 6b in the building 2 and projects a second image 8b onto a second screen 7b. The second projector 50b includes a second light source 51b, a second controller 52b, and a second operation unit 53b. The second projector 50b does not include an illuminance sensor.

The third projector 50c is disposed in a third area 3c including a third window 5c and a third light 6c in the building 2 and projects a third image 8c onto a third screen 7c. The third projector 50c includes a third light source 51c, a third controller 52c, and a third operation unit 53c. The third projector 50c does not include an illuminance sensor.

Hereinafter, the first area 3a, the second area 3b, and the third area 3c are collectively referred to as area(s) 3, the first window 5a, the second window 5b, and the third window 5c are collectively referred to as window(s) 5, and the first lighting 6a, the second lighting 6b, and the third lighting 6c are collectively referred to as light(s) 6. The areas 3 may be separate rooms or may be different regions in the same room. The first screen 7a, the second screen 7b, and the third screen 7c are collectively referred to as screen(s) 7 and the first image 8a, the second image 8b, and the third image 8c are collectively referred to as image(s) 8.

The first projector 50a, the second projector 50b, and the third projector 50c are collectively referred to as projector(s) 50 and the first light source 51a, the second light source 51b, and the third light source 51c are collectively referred to as light source(s) 51. The first controller 52a, the second controller 52b, and the third controller 52c are collectively referred to as controller(s) 52 and the first operation unit 53a, the second operation unit 53b, and the third operation unit 53c are collectively referred to as operation unit(s) 53.

The projector 50 includes a not-illustrated light modulation device and a not-illustrated optical system in addition to the light source 51. The light source 51 is a light emitting diode (LED) light source, a laser light source, or the like. The light modulation device includes at least one liquid crystal panel or at least one digital micromirror device. Functions of the light source 51 and the light modulation device may be implemented by a micro LED panel. The optical system includes at least one lens or mirror and enlarges and projects image light from the light modulation device toward the screen 7. The optical system may include a zoom mechanism that enlarges or reduces the image 8, a focus adjustment mechanism that adjusts focus, a lens shift mechanism that adjusts a projection direction of the image light, and the like.

The controller 52 is a control device including at least one processor, a memory, and a communication circuit. The controller 52 controls an operation of the projector 50 and performs communication via the router 4 by executing, with the processor, a program for controlling the projector 50 stored in the memory. The at least one processor may include a system-on-a-chip (SoC) integrated with a part or the entire memory and other circuits. The processor may be a combination of a central processing unit (CPU) that executes a program and a digital signal processor (DSP) that executes predetermined arithmetic processing. All of functions of the processor may be implemented in hardware or may be configured using a programmable device. The memory includes a magnetic storage device, a semiconductor storage element such as a flash read only memory (ROM), or a nonvolatile storage device of another type. The memory may include a random access memory (RAM) that configures a work area of the processor. The communication circuit includes, for example, a signal processing circuit that processes a signal from a communication interface conforming to a publicly-known communication standard. The user U operates the operation unit 53 to, for example, set the luminance of the light source 51. The operation unit 53 is, for example, various buttons and switches provided on a housing surface of the projector 50 or a not-illustrated remote controller.

The support server 10 is a computer system including a communicator 11, a processor 12, and a storage device 20. Specific configurations of the communicator 11, the processor 12, and the storage device 20 are respectively the same as the configurations of the communication circuit, the processor, and the memory of the projector 50. The processor 12 may include one or a plurality of processors. A program 21 for controlling the support server 10 and a projector DB 22, which is a database in which information concerning the plurality of projectors is recorded, are saved in the storage device 20.

The support server 10 executes the program 21 with the processor 12 to thereby execute diversion control for illuminance information. The diversion control for the illuminance information is control for changing, based on the detected illuminance of the illuminance sensor 54a, set luminance of the second projector 50b and the third projector 50c not including illuminance sensors. Details of the diversion control for the illuminance information are explained below.

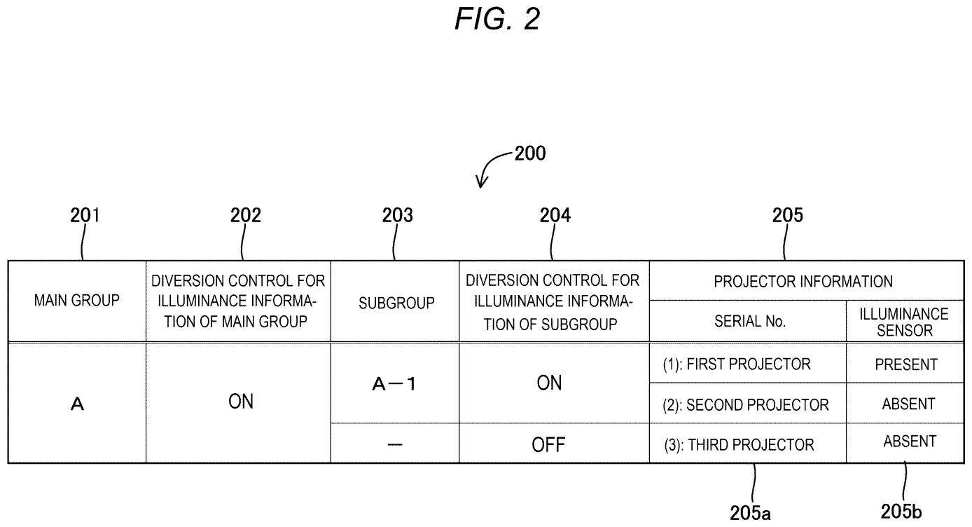

The support server 10 manages a plurality of projectors 50 with a first management table 200 illustrated in FIG. 2 in order to execute, for the plurality of projectors 50, the diversion control for the illuminance information. Data of the first management table 200 is saved in the projector DB 22. In an example illustrated in FIG. 2, the first management table 200 includes a main group A and a subgroup A-1. The first projector 50a and the second projector 50b belong to the subgroup A-1. The third projector 50c belongs to the main group A but does not belong to the subgroup A-1. The main group A and the subgroup A-1 are equivalent to a management group serving as a unit for managing a plurality of projectors. In the present embodiment, the subgroup A-1 is equivalent to a first management group.

The user U can input items 201 to 205 of the first management table 200 by operating the operation unit 53 or by operating a projector management application saved in the communication terminal 70. Hereinafter, the operation of the operation unit 53 or the communication terminal 70 by the user U is referred to as “operation by the user U”. The processor 12 of the support server 10 receives information or a control signal corresponding to the operation by the user U via the projector 50 or from the communication terminal 70. The number of main groups of the item 201, the number of subgroups of the item 202, and the number of layers of the management group are not limited to the example illustrated in FIG. 2 and can be added and deleted according to the operation by the user U. The numbers of projectors 50 belonging to management groups are also optional and only has to be one or more. The diversion control for the illuminance information can be executed if there are two or more projectors 50. A serial number of projector information of the item 205 and the presence or absence of an illuminance sensor may be input by the support server 10 based on equipment information of the projectors 50 acquired by the support server 10 through communication with the projectors 50.

The support server 10 updates and stores the first management table 200 according to the operation by the user U to thereby store a correspondence relationship between the projector 50 and the main group A and the subgroup A-1.

An item 202 indicates whether to perform the diversion control for the illuminance information in the main group. An item 204 indicates whether to perform the diversion control for the illuminance information in the subgroup. In FIG. 2, “ON” indicates that the diversion control is performed and “OFF” indicates that the diversion control is not performed. According to the operation by the user U, the support server 10 acquires information for selecting ON or OFF in the item 202 or the item 204. The information for selecting ON or OFF in the item 202 or the item 204 is equivalent to second selection information. In the first management table 200, by selecting ON in the item 204, it is determined that illuminance information of the illuminance sensor 54a provided in the first projector 50a is diverted. Therefore, the information for selecting ON or OFF in the item 204 is equivalent to first selection information for selecting at least one of a plurality of projectors belonging to the first management group. The first projector 50a is equivalent to a projector indicated by the first selection information. When a plurality of projectors including illuminance sensors belong to the subgroup A-1, according to the operation by the user U, the support server 10 may acquire information for selecting one or more projectors that refer to the illuminance information. In this case, the information for selecting one or more projectors that refer to the illuminance information is equivalent to the first selection information.

When diversion control for illuminance information of the main group A is set to OFF in the item 202, diversion control for illuminance information of the subgroup A-1 of the item 204 is also set to OFF in association with the setting. When the diversion processing of the illuminance information of the main group A of the item 202 is set to ON, setting of the diversion control for the illuminance information of the subgroup A-1 of the item 204 is switched between ON and OFF according to the operation of the user U. Further, since the support server 10 executes the diversion control for the illuminance information in a subgroup unit, the diversion control of the illuminance information is set to OFF for the third projector 50c in which a subgroup is not set.

### 2. Diversion Control for Illuminance Information

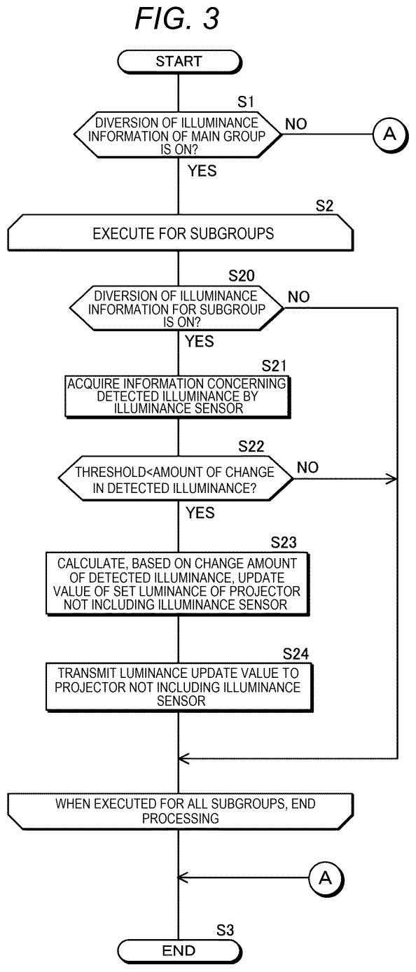

A procedure of diversion control for illuminance information executed by the support server 10 is explained according to the flowchart illustrated in FIG. 3. The support server 10 repeatedly executes the processing by the flowchart illustrated in FIG. 3 in a predetermined control cycle. The predetermined control cycle may be a cycle determined by an administrator of the display control system 1 or may be a cycle set by the user U. The cycle is, for example, 10 minutes, 1 hour, or half a day.

In step S1 in FIG. 3, the support server 10 refers to the first management table 200 and determines, for the main group A, whether setting of the diversion control for the illuminance information is ON or OFF. If the setting of the diversion control for the illuminance information is ON, the support server 10 advances the processing to step S2 (step S1: YES). When the setting of the diversion control for the illuminance information is OFF, the support server 10 advances the processing to step S3 (step S1: NO) and ends the processing in the current control cycle.

In step S2, the support server 10 executes processing in steps S20 to S24 for subgroups recorded in the first management table 200. Since only the subgroup A-1 is set in the first management table 200, the support server 10 executes the processing in steps S20 to S24 on the subgroup A-1.

In step S20, the support server 10 refers to the first management table 200 and determines whether setting of diversion control for illuminance information for the subgroup A-1 is ON or OFF. When the setting of the diversion control for the illuminance information for the subgroup A-1 is ON, the support server 10 advances the processing to step S21 (step S20: YES). When the setting of the diversion control for the illuminance information for the subgroup A-1 is OFF, the support server 10 ends the processing for the subgroup A-1 (step S20: NO).

In step S21, the support server 10 communicates with the first projector 50a including the illuminance sensor 54a, acquires information concerning detected illuminance by the illuminance sensor 54a, and stores the information in the projector DB 22. The information concerning the detected illuminance in this case is equivalent to information indicating first illuminance of the present disclosure. The information concerning the detected illuminance may be a measurement value (lx) by the illuminance sensor 54a, an amount of change from detected illuminance in the last control cycle or an average value of a nearest plurality of times of measurement results.

In the subsequent step S22, the support server 10 determines whether the amount of change in the detected illuminance by the illuminance sensor 54a from the detected illuminance in the previous control cycle is larger than a predetermined threshold. When the amount of change in the detected illuminance by the illuminance sensor 54a is larger than the threshold, the support server 10 advances the processing to step S23 (step S22: YES). When the amount of change in the detected illuminance by the illuminance sensor 54a is equal to or smaller than the threshold, the support server 10 ends the processing for the subgroup A-1 (step S22: NO). The change amount of the detected illuminance may be a difference between the last detected illuminance and the current detected illuminance, the absolute value of the difference, or a change rate (%) of the current detected illuminance with respect to the last detected illuminance.

In step S23, the support server 10 calculates an update value of set luminance of the second projector 50b not including an illuminance sensor based on the change amount of the detected illuminance of the illuminance sensor 54a according to, for example, the following Expression (1).

$$SB\_U = SB\_C + K \cdot Δ B \qquad ( 1 )$$

where, SB_U is an update value of set luminance calculated in the current control cycle, SB_C is a current value of the set luminance of the second projector 50b, K is an adjustment coefficient, and ΔB is a change amount of the detected illuminance.

The support server 10 communicates with the second projector 50b to thereby acquire the current value SB_C of the set luminance of the second projector 50b. The current value SB_C of the set luminance of the second projector 50b is an example of setting information concerning the luminance of the image 8b set in the second projector 50b. Calculating the update value SB_U of the set luminance of the second projector 50b using the current value SB_C of the set luminance of the second projector 50b is equivalent to determining control information based on the setting information concerning the luminance of the image 8b set in the second projector 50b.

The adjustment coefficient K is set according to a level of a correlation of illuminance between the second area 3b where the second projector 50b is disposed and the first area 3a where the first projector 50a including the illuminance sensor 54a is disposed. The adjustment coefficient K may be a value larger than 0 and equal to or smaller than 1. In this case, for example, the adjustment coefficient K is set to a larger value as the correlation is higher. For simplification of control, K may be set to 1. In step S23, the support server 10 or the first projector 50a updates the set luminance of the first projector 50a according to the amount of change in the detected illuminance. ΔB may be the difference between a value before the update and a value after the update of the set luminance of the first projector 50a. Calculating an update value of the set luminance based on the detected illuminance of the illuminance sensor 54a is equivalent to determining, based on information indicating first illuminance, control information for controlling the brightness of the second image 8b projected by the second projector 50b. The control information may be the update value itself of the set luminance or may be information, based on the update value of the set luminance, for controlling the luminance of the second projector 50b.

In the subsequent step S24, the support server 10 transmits the update value of the set luminance to the second projector 50b. The second projector 50b changes the set luminance to the received update value. Accordingly, the control information for controlling the brightness of the second image 8b projected by the second projector 50b is determined based on the detected illuminance of the illuminance sensor 54a.

### 3. Other Embodiments

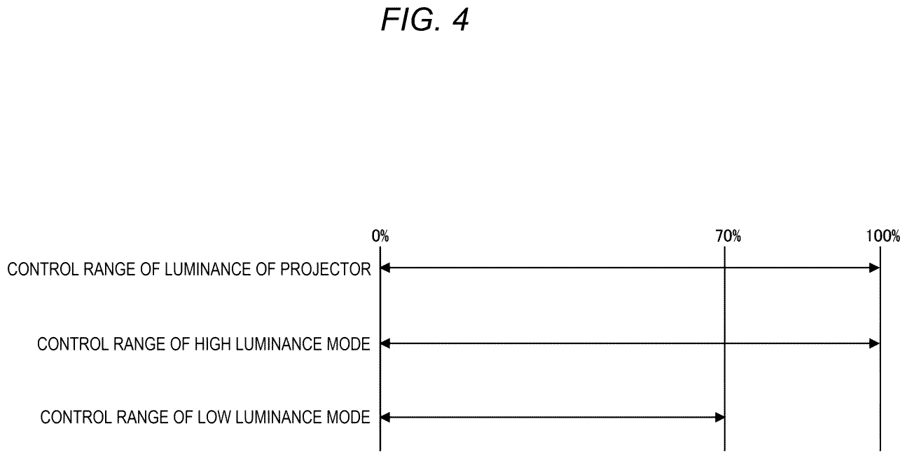

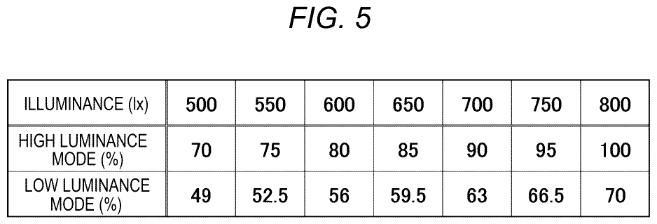

Control for calculating an update value of the set luminance in the case in which a setting range of the luminance of the projector 50 can be switched between a high luminance mode and a low luminance mode is explained with reference to FIGS. 4 and 5. This control is equivalent to step S23 in FIG. 3. The high luminance mode and the low luminance mode are collectively referred to as luminance mode(s). The same components as the components explained with reference to FIGS. 1 to 3 are denoted by the same reference numerals and signs and explanation of the components is omitted.

FIG. 4 is a diagram illustrating control ranges of the luminance modes. As illustrated in FIG. 4, when a maximum control range of the luminance of the light source 51 of the projector 50 is set to 0 to 100%, the control range of the high luminance mode is set to 0 to 100% and the control range of the low luminance mode is set to 0 to 70%. Therefore, ranges of luminance applicable when the projector 50 projects the image 8 are different between the high luminance mode and the low luminance mode. The projector 50 is set to the high luminance mode or the low luminance mode according to the operation by the user U. When one of the two luminance modes is selected by the operation by the user U, the projector 50 enables the selected luminance mode and stores information indicating the selected luminance mode in the memory as setting information. The luminance mode is an example of setting information concerning luminance.

FIG. 5 is a diagram illustrating a correspondence relationship between setting of the luminance modes and illuminance. As illustrated in FIG. 5, in the projector 50, a correspondence relationship between illuminance (lx) of an environment in which the projector 50 is disposed and set luminances (%) of luminances in the high luminance mode and the low luminance mode is determined. More specifically, FIG. 5 represents a correspondence relationship between a range of luminance by the high luminance mode and a range of luminance by the low luminance mode as a correspondence relationship between set values (%) of luminance of the luminance modes at the illuminances. Numerical values in FIG. 5 are examples. The support server 10 calculates an update value of set luminance based on the correspondence relationship illustrated in FIG. 5 according to the luminance mode selected in the projector 50.

For example, it is assumed that the high luminance mode is selected and the current set luminance is 80% in the first projector 50a. It is assumed that the low luminance mode is selected and the current set luminance is 56% in the second projector 50b. A setting range of luminance by the high luminance mode in the first projector 50a is equivalent to a first luminance range. A setting range of luminance by the low luminance mode in the second projector 50b is equivalent to a second luminance range. The current set luminance is another example of the setting information concerning the luminance. Here, it is assumed that detected illuminance of the illuminance sensor 54a has increased from 600 (lx) to 650 (lx). An amount of change in illuminance is 50 (lx). In this case, the support server 10 updates set luminance as follows.

The support server 10 acquires setting information of the first projector 50a and the second projector 50b through communication with the first projector 50a and the second projector 50b. Specifically, the support server 10 acquires luminance modes of the first projector 50a and the second projector 50b. Since the illuminance is 650 (lx), the support server 10 sets the update value of the set luminance to 85 (%) for the first projector 50 a and sets the update value of the set luminance to 59.5 (%) for the second projector 50b based on the correspondence relationship illustrated in FIG. 5. Accordingly, update values of the set luminances of the first projector 50a and the second projector 50b are calculated based on the correspondence relationship between the range of luminance of the high luminance mode and the range of luminance of the low luminance mode and the detected illuminance.

The update value of the set luminance of the second projector 50b may be calculated not based on the change amount of the detected illuminance by the illuminance sensor 54a but based on a change rate of the detected illuminance. As an example, the change rate of the detected illuminance can be calculated as a ratio of the change amount of the detected illuminance to a size of a range of illuminance corresponding to a range of the luminance mode. For example, in the high luminance mode, a size of a range of illuminance corresponding to a range of illuminance of 70 to 100 (%) is 800-500=300 (lx). Therefore, when the detected illuminance by the illuminance sensor 54a increases by 50 (lx), a change rate of detected illuminance in the first projector 50a in which the high luminance mode is selected is approximately 17% with respect to the range of the luminance of 70 to 100 (%). For that reason, the update value of the set luminance of the second projector 50b in which the low luminance mode is selected is set to 56 (current set luminance)+(70−49)×0.17=59.6 (%). An update value of the set luminance of the first projector 50a at this time may be determined based on an increase amount of the illuminance or may be determined by the same calculation method as the calculation method for the second projector 50b. A target range of luminance may be divided into several ranges as explained above or an entire range from minimum luminance to maximum luminance applicable in the luminance modes may be set as a target.

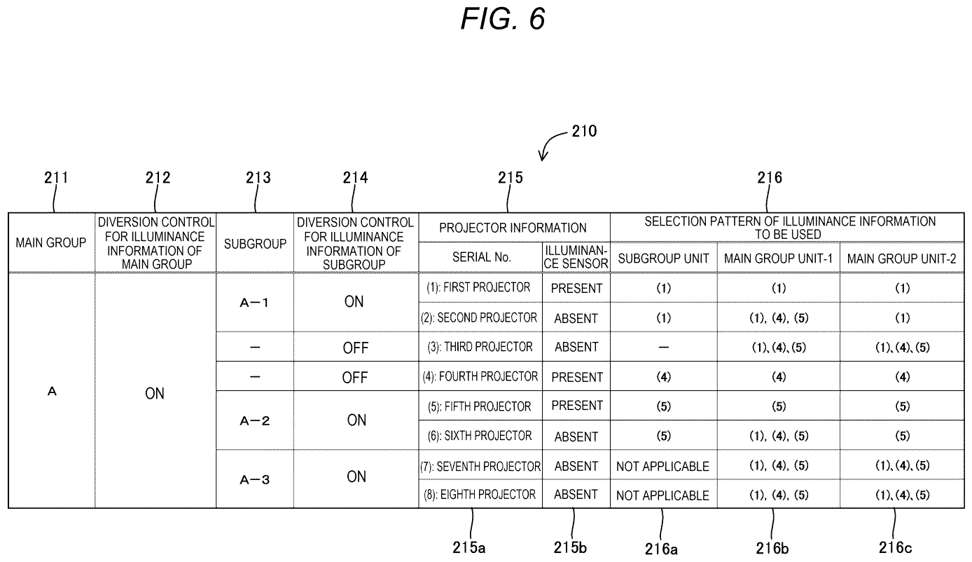

Next, with reference to FIG. 6, diversion control for illuminance information in the case in which a plurality of subgroups are set is explained. FIG. 6 illustrates the second management table 210 in which eight projectors of a first projector to an eighth projector belong to the main group A and the main group A includes three subgroups A-1, A-2, and A-3.

The second management table 210 includes an item 211 indicating setting of the main group A, an item 212 indicating setting of ON/OFF of diversion control for illuminance information for the main group A, and an item 213 indicating setting of the subgroups A-1, A-2, and A-3. The second management table 210 includes an item 214 indicating setting of ON/OFF of diversion control for illuminance information for the subgroups, and an item 215 indicating information concerning the projectors belonging to the main group A. Further, the second management table 210 includes an item 216 indicating a selection pattern of illuminance information used for updating set luminances of the projectors. The item 212 or the item 214 is equivalent to second selection information. The item 214 is equivalent to the first selection information.

The item 215 includes an item 215a indicating serial numbers (1) to (8) of the eight projectors and an item 215b indicating the presence or absence of an illuminance sensor. The item 216 includes an item 216a indicating a selection mode of illuminance information in a subgroup unit, an item 216b indicating a selection mode of illuminance information in a main group unit-1, and an item 216c indicating a selection mode of illuminance information in a main group unit-2. In the item 216, illuminance information in use is indicated by the serial numbers (1), (4), and (5) of the projectors including illuminance sensors.

The item 216 may include any one item or may include two or more items among the item 216a, the item 216b, and the item 216c. When the item 216 includes any one item, the support server 10 executes processing corresponding to the item. When the item 216 includes two or more items, the support server 10 may acquire information for selecting which item is to be applied and perform processing corresponding to the selected item according to the operation by the user U.

In the subgroup unit of the item 216a, when the item 214 is ON, detected illuminance of an illuminance sensor provided in a projector belonging to the same subgroup is referred to. Therefore, the item 216a includes the following patterns (P1-1) to (P1-4). Update values of set luminance of target projectors are calculated by diversion control for illuminance information in the patterns (P1-1) and (P1-2).
(P1-1) Concerning the first projector and the second projector belonging to the subgroup A-1, the first projector including the illuminance sensor calculates an update value of set luminance based on detected illuminance of the illuminance sensor provided in the first projector. For the second projector, an update value of set luminance is calculated by the support server 10 based on information concerning detected illuminance by the illuminance sensor provided in the first projector.
(P1-2) Concerning the fifth projector and the sixth projector belonging to the subgroup A-2, the fifth projector including the illuminance sensor calculates an update value of set luminance using detected illuminance of the illuminance sensor provided in the fifth projector. For the sixth projector, an update value of set luminance is calculated by the support server 10 based on information concerning detected illuminance by the illuminance sensor provided in the fifth projector.
(P1-3) Concerning the seventh projector and the eighth projector belonging to the subgroup A-3, since both the projectors do not include an illuminance sensor, information concerning detected illuminance cannot be diverted and an update value of a set luminance cannot be calculated based on the detected illuminance. For that reason, although the item 214 is ON, since the information concerning the detected illuminance cannot be diverted, an update value of set luminance based on the detected illuminance is not calculated.
(P-14) Concerning the third projector and the fourth projector not belonging to all the subgroups, the fourth projector including the illuminance sensor calculates an update value of set luminance based on detected illuminance of the illuminance sensor provided in the fourth projector. The third projector not including the illuminance sensor does not calculate an update value of set luminance based on detected illuminance.

In the main group unit-1 of the item 216b, when the item 212 is ON, diversion control for illuminance information is performed among projectors belonging to the same main group. In the item 216b, update values of set luminances of the projectors are calculated by the following patterns (P2-1) and (P2-2). In the item 216b and the item 216c, diversion control for illuminance information is possible even when the item 214 is OFF or when a projector including an illuminance sensor is not included in a subgroup. In this case, the main group A is an example of the first management group. When the item 216b or the item 216c is applied, step S20 in FIG. 3 is omitted.
(P2-1) The first projector, the fourth projector, and the fifth projector including illuminance sensors calculate update values of set luminance based on detected illuminances of the illuminance sensors provided in the projectors.
(P2-2) Concerning the second projector, the third projector, the sixth projector, the seventh projector, and the eighth projector not including illuminance sensors. For the projectors not including illuminance sensors, information concerning detected illuminances of illuminance sensors provided in the other projectors belonging to the main group A is diverted. That is, the support server 10 acquires detected illuminance of at least one of the illuminance sensors respectively provided in the first projector, the fourth projector, and the fifth projector and calculates update values of set luminances of the projectors not including illuminance sensors. The support server 10 may use detected illuminance of an illuminance sensor provided in any one of the first projector, the fourth projector, and the fifth projector. The support server 10 may perform statistical processing for detected illuminances of illuminance sensors and calculate an illuminance index targeting two or more projectors among the first projector, the fourth projector, and the fifth projector. The support server 10 may acquire, according to the operation by the user U, information for selecting detected illuminance of which illuminance sensor is used. In this case, the information for selecting detected illuminance of which illuminance sensor is used is equivalent to the first selection information. Then, the support server 10 calculates, based on the illuminance index, update values of set luminances of the second projector, the third projector, the sixth projector, the seventh projector, and the eighth projector not including illuminance sensors. The statistical processing is processing for calculating a simple average, a weighted average, a mode, or the like. Weighting of the weighted average may be set according to a correlation of the illuminance of an environment in which the projectors are disposed. As a result of the statistical processing, the illuminance index is obtained. Any two of a plurality of projectors including illuminance sensors to be subjected to the statistical processing are equivalent to the first projector and the third projector of the present disclosure.

In this case, for the seventh projector and the eighth projector belonging to the subgroup A-3 not including a projector including an illuminance sensor, information concerning detected illuminances of the illuminance sensors provided in the projectors belonging to the other subgroups A-1 and A-2 is diverted. The subgroups A-1 and A-2 are examples of a first management group and the subgroup A-3 is an example of a second management group. The seventh projector and the eighth projector are examples of a fourth projector belonging to the second management group.

In the main group unit-2 of the item 216c, update values of set luminances of projectors are calculated by the following patterns (P3-1), (P3-2), and (P3-3). In the item 216b, detected illuminance of an illuminance sensor provided in any projector belonging to the same group is used. In contrast, in the item 216c, when projectors in the same subgroup include illuminance sensors, detected illuminances of the illuminance sensors in the same subgroup are used.
(P3-1) The first projector, the fourth projector, and the fifth projector including the illuminance sensors calculate update values of set luminances based on detected illuminances of the illuminance sensors provided in the projectors.
(P3-2) For a projector not including an illuminance sensor and belonging to any subgroup, an update value of set luminance is calculated by diverting information concerning detected illuminance of an illuminance sensor provided in a projector belonging to the same subgroup. Specifically, the support server 10 calculates an update value of set luminance of the second projector based on detected illuminance of the illuminance sensor provided in the first projector. The support server 10 calculates an update value of set luminance of the sixth projector based on detected illuminance of the illuminance sensor provided in the fifth projector.
(P3-3) For a projector not including an illuminance sensor and not belonging to any subgroup, an update value of set luminance is calculated by diverting information concerning detected illuminances of illuminance sensors provided in the other projectors belonging to the main group A. Also for the projector belonging to the subgroup A-3 to which a projector including an illuminance sensor does not belong, an update value of set luminance is calculated using detected illuminances of illuminance sensors provided in the other projectors belonging to the main group A. Specifically, as in (P2-2) explained above, the support server 10 calculates an illuminance index by performing the statistical processing for the detected illuminances of the illuminance sensors provided in the first projector, the fourth projector, and the fifth projector. Then, the support server 10 calculates update values of the set luminances of the third projector, the seventh projector, and the eighth projector based on the illuminance index. The subgroup A-3 is an example of the second management group.

In the embodiment explained above, a case in which a display control method of the present disclosure is executed by the support server 10 is explained. However, the display control method of the present disclosure may be executed by the controller 52 of any one of the plurality of projectors 50 that communicate with one another. Alternatively, the display control method of the present disclosure may be executed by the communication terminal 70 by performing communication between the communication terminal 70 and a plurality of projectors.

In the embodiment explained above, the diversion control for the illuminance information is executed on a projector not including an illuminance sensor. The support server 10 may execute the diversion control for the illuminance information when information concerning detected illuminance is not acquired even if a projector includes an illuminance sensor. For example, when detection of illuminance by an illuminance sensor is unsuccessful, illuminance information of the other projectors may be diverted to a projector including the illuminance sensor.

### 4. SUMMARY OF THE PRESENT DISCLOSURE

A summary of the present disclosure is appended below.

### Appendix 1

A display control method including: acquiring information indicating first illuminance that is illuminance of an environment in which a first projector belonging to a first management group that is a management group serving as a unit for managing a plurality of projectors is disposed; and determining, based on the information indicating the first illuminance, control information for controlling brightness of an image projected by a second projector belonging to the first management group.

With the display control method described in Appendix 1, a control condition for the brightness of the image projected by the second projector can be determined based on the information indicating the first illuminance that is the illuminance of the environment in which the first projector is disposed. Therefore, even when the illuminance of an environment in which the second projector is disposed cannot be detected, it is possible to determine, according to the illuminance of the environment, the control information for controlling the brightness of the image projected by the second projector.

### Appendix 2

The display control method described in Appendix 1, in which the determining the control information includes determining the control information based on setting information concerning luminance of an image set in the second projector and information indicating the first illuminance.

Consequently, it is possible to determine, taking into account setting information concerning the luminance of an image individually set for the second projector, the control information for controlling the brightness of the image projected by the second projector.

Appendix 3

The display control method described in Appendix 2, in which the setting information indicates any one of a plurality of luminance modes in which ranges of luminance applicable when the image is projected are different from one another.

Accordingly, it is possible to determine control information for the second projector corresponding to a luminance mode individually selected for the second projector.

### Appendix 4

The display control method described in Appendix 3, in which the determining the control information includes determining the control information based on the first illuminance and a correspondence relationship between a first luminance range that is a range of luminance by a luminance mode indicated by the setting information set in the first projector and a second luminance range that is a range of luminance by a luminance mode indicated by the setting information set in the second projector.

Accordingly, even when the first luminance range by the luminance mode of the first projector and the second luminance range by the luminance mode of the second projector are different, it is possible to determine the control information of the second projector based on the correspondence relationship between the first luminance range and the second luminance range.

### Appendix 5

The display control method described in any one of Appendixes 1 to 4, further including acquiring information indicating third illuminance that is illuminance of an environment in which a third projector belonging to the first management group is disposed, in which the determining the control information includes determining the control information based on a result of statistical processing for the information indicating the first illuminance and the information indicating the third illuminance.

Accordingly, it is possible to determine a control condition of the second projector using the result of the statistical processing for the first illuminance and the third illuminance for the first projector and the third projector belonging to the same management group. It is possible to determine the control condition of the second projector using a value more appropriately representing the illuminance of an environment in which projectors belonging to the same management group are disposed than when the illuminance of one projector is used.

Appendix 6

The display control method described in any one of Appendixes 1 to 5, further including acquiring first selection information for selecting at least one of a plurality of projectors belonging to the first management group, in which the first projector is a projector indicated by the first selection information.

Accordingly, it is possible to select any one of the plurality of projectors belonging to the management group as the first projector.

### Appendix 7

The display control method according to any one of Appendixes 1 to 6, further including acquiring second selection information for selecting whether to determine the control information, in which the determining the control information includes determining the control information when the second selection information indicates that the control information is determined.

Accordingly, it is possible to enable selection of whether to determine the control information of the second projector based on the first illuminance acquired for the first projector.

### Appendix 8

The display control method according to any one of Appendixes 1 to 7, further including, when, for all projectors belonging to a second management group different from the first management group, information indicating illuminance of an environment in which the projectors are disposed is not acquired, determining, based on the information indicating the first illuminance, control information for controlling brightness of an image projected by a fourth projector belonging to the second management group.

Accordingly, when the plurality of projectors are divided into a plurality of management groups, even for the fourth projector belonging to the second management group in which information indicating illuminance is not acquired for all the projectors, it is possible to determine control information based on the first illuminance of the first management group.

### Appendix 9

A non-transitory computer-readable storage medium storing a program for causing a computer to execute: acquiring information indicating first illuminance that is illuminance of an environment in which a first projector belonging to a management group serving as a unit for managing a plurality of projectors is disposed; and determining, based on the information indicating the first illuminance, a control condition for controlling brightness of an image projected by a second projector belonging to the management group.

By executing the program described in Appendix 9 with the computer, it is possible to obtain the same action effects as the action effects of the display control method described in Appendix 1.

### Appendix 10

A display control system including: an illuminance sensor configured to detect illuminance of an environment in which a first projector is disposed; a second projector; and a control device configured to determine, based on the illuminance detected by the illuminance sensor, a control condition for controlling brightness of an image projected by the second projector.

With the display control system described in Appendix 10, a control condition for the brightness of the image projected by the second projector can be determined based on the information indicating the first illuminance that is the illuminance of the environment in which the first projector is disposed. Therefore, even when the illuminance of an environment in which the second projector is disposed cannot be detected, it is possible to determine, according to the illuminance of the environment, the control information for controlling the brightness of the image projected by the second projector.

What is claimed is:

1. A display control method comprising:
acquiring information indicating first illuminance that is illuminance of an environment in which a first projector belonging to a first management group that is a management group serving as a unit for managing a plurality of projectors is disposed; and
determining, based on the information indicating the first illuminance, control information for controlling brightness of an image projected by a second projector belonging to the first management group.

2. The display control method according to claim 1, wherein the determining the control information includes determining the control information based on setting information concerning luminance of an image set in the second projector and information indicating the first illuminance.

3. The display control method according to claim 2, wherein the setting information indicates any one of a plurality of luminance modes in which ranges of luminance applicable when the image is projected are different from one another.

4. The display control method according to claim 3, wherein the determining the control information includes determining the control information based on the first illuminance and a correspondence relationship between a first luminance range that is a range of luminance by a luminance mode indicated by the setting information set in the first projector and a second luminance range that is a range of luminance by a luminance mode indicated by the setting information set in the second projector.

5. The display control method according to claim 1, further comprising acquiring information indicating third illuminance that is illuminance of an environment in which a third projector belonging to the first management group is disposed, wherein
the determining the control information includes determining the control information based on a result of statistical processing for the information indicating the first illuminance and the information indicating the third illuminance.

6. The display control method according to claim 1, further comprising acquiring first selection information for selecting at least one of a plurality of projectors belonging to the first management group, wherein
the first projector is a projector indicated by the first selection information.

7. The display control method according to claim 1, further including acquiring second selection information for selecting whether to determine the control information, wherein
the determining the control information includes determining the control information when the second selection information indicates that the control information is determined.

8. The display control method according to claim 1, further comprising: when, for all projectors belonging to a second management group different from the first management group, information indicating illuminance of an environment in which the projectors are disposed is not acquired, determining, based on the information indicating the first illuminance, control information for controlling brightness of an image projected by a fourth projector belonging to the second management group.

9. A non-transitory computer-readable storage medium storing a program for causing a computer to execute:
acquiring information indicating first illuminance that is illuminance of an environment in which a first projector belonging to a management group serving as a unit for managing a plurality of projectors is disposed; and
determining, based on the information indicating the first illuminance, a control condition for controlling brightness of an image projected by a second projector belonging to the management group.

10. A display control system comprising:
an illuminance sensor configured to detect illuminance of an environment in which a first projector is disposed;
a second projector; and
a control device configured to determine, based on the illuminance detected by the illuminance sensor, a control condition for controlling brightness of an image projected by the second projector.
